(19) United States
(12) Patent Application Publication
(10) Pub. No.: US 2014/0215127 A1
(43) Pub. Date: Jul. 31, 2014

(54) APPARATUS, SYSTEM, AND METHOD FOR ADAPTIVE INTENT LOGGING

(71) Applicant: ORACLE INTERNATIONAL CORPORATION, Redwood City, CA (US)

(72) Inventors: Neil Veness Perrin, Westminster, CO (US); Bradley Romain Lewis, Broomfield, CO (US)

(73) Assignee: ORACLE INTERNATIONAL CORPORATION, Redwood City, CA (US)

(21) Appl. No.: 13/756,012

(22) Filed: Jan. 31, 2013

(51) Int. Cl. G06F 12/02

(52) U.S. Cl. CPC G06F 12/0246
USPC 711/103; 711/114

(57) ABSTRACT

A system and method is provided for implementing adaptive intent logging in a file system of a computing device. The file system receives an I/O request from one more applications executing on the computing device. The file system includes one or more intent logging modules that adaptively and/or selectively write detail data included in an I/O request directly to storage pool device or an intent log that based on logging rules and/or the detail data associated with the request. The intent logging modules minimizes processing delays when an application issues multiple synchronous requests, such as small write request.

### TECHNICAL FIELD

Aspects of the present disclosure relate to computer systems and file storage systems, and in particular, systems and methods for enabling adaptive intent logging of input/output requests issued to a file system.

### BACKGROUND

As the number of computing devices increase across society, electronic data management has become increasingly challenging. Modern devices create and use ever increasing amounts of electronic data ranging from digital photos and videos, to large data sets related to any number of topics including energy exploration, human resources, seismic activity, and gene research. This explosion in digital data has naturally led to ever increasingly large amounts of data that must be stored. Correspondingly, the data storage field is under constant pressure to increase size, performance, accessibility, reliability, security, and efficiency of data storage systems.

Computing devices typically include file systems that provide procedures for storing, retrieving, and updating data associated with operations performed by an application or program executing on that computing devices. These file systems also manage the available space on the device(s) that store such data. It is important that file systems also be equipped with data recovery tools to minimize the loss of pertinent data as a result of an event failure, such as a power failure or, hardware failure.

As a result, conventional file systems may include an intent logging feature to improve the resiliency of computer operations in the event of such failures. Intent logging refers to a process where the file system writes a record of the intent to perform a particular operation before actually performing that particular operation. The record is usually written to an intent log that is maintained in some relatively permanent or otherwise non-volatile medium, such as a hard disk.

Conventional file systems and volume managers provide many services through their IO interfaces such as encryption, compression, asynchrony, aggregation, queuing, and resource scheduling. Unfortunately, there is considerable overhead in using the full services due to the framework and code needed to support them. However, the vast majority of these services are not necessary for a simple intent log facility to ensure synchronous data is stable. Occasionally more complex services are still required for complex writes, such as large writes, and so for optimal performance the code greatly benefits by adapting to the requirements of the particular synchronous transaction workload which generates the intent log transactions.

Thus, there is a desire for file systems that can adaptively avoid high overhead services associated with simple requests, such as a small write or file rename. It is with these and other issues in mind that various aspects of the present disclosure were developed.

### SUMMARY

According to one aspect, a system for adaptive intent logging in a file system is provided. The system includes at least one processor and a file system that is executed by the at least one processor. The file system receives a write request from at least one application being executed by the at least one processor. The write request includes detail data.

The system includes at least one intent logging module executed by the file system in response to the write request. The at least one intent logging module processes the detail data to determine if the write request is a first request type or a second request type. The at least one intent logging module writes a record comprising at least a portion of the detail data to at least one storage pool device when the write request is the first request type and writes the record comprising the at least the portion of the detail data to an intent log when the write request is the second request type.

According to another aspect, a system is provided for adaptive intent logging by a file system operating on a computing device. The system includes at least one processor and a file system executing on the at least one processor to receive a write request from at least one application being executed by the at least one processor. The write request includes detail data.

The system also includes at least one intent logging module executed by the file system in response to the I/O request. The at least one intent logging module further processes the write request to identify one or more types of the detail data. The at least one intent logging module also selectively writes a record comprising at least a portion of the detail data to one of a storage pool device and a separate intent log based on a comparison of the one or more types of detail data identified and one or more intent logging rules.

According to another aspect, a method is provided for adaptive intent logging in a file system. The method includes receiving a write request at a file system executing on at least one processor from at least one application being executed by the at least one processor. The write request includes detail data. The method also includes processing the detail data to determine if the write request is a first request type or a second request type. The method further includes writing a record comprising at least a portion of the detail data to at least one storage pool device when the write request is the first request type. The method also includes writing the record comprising the at least the portion of the detail data to an intent log when the write request is the second request type.

### BRIEF DESCRIPTION OF THE FIGURES

Aspects of the present disclosure may be better understood and its numerous objects, features, and advantages made apparent to those skilled in the art by referencing the accompanying drawings. It should be understood that these drawings depict only typical embodiments of the present disclosure and, therefore, are not to be considered limiting in scope.

FIG. 1 is a block diagram of a computing environment for implementing an adaptive intent logging system according to one aspect of the disclosure.

FIG. 2A is a block diagram of a file system configured with adaptive logging modules according to one aspect of the adaptive intent logging system.

FIG. 2B is block diagram of an I/O request.

FIG. 3 illustrates a method for implementing an adaptive intent logging system according to one aspect of adaptive intent logging system.

### DETAILED DESCRIPTION

Aspects of the present disclosure involve a system and method for advantageously avoiding overhead services associated with synchronous requests such as small write requests issued to a file system by an application being executed on a computer system. In particular, the present disclosure involves a system and method for improving intent logging in file systems. Intent logging refers to a process where the file system writes a log block of the intent to perform a particular operation associated with a particular write request before actually performing that particular operation.

According to one aspect, the system and method adaptively bypass the file system I/O services layer that requires additional processing time, and records data associated with selected I/O requests directly to the intent log device. The decision to bypass the file system I/O services layer may be based on one or more data parameters of a received input/output (I/O) output request. Since services, such as encryption and compression, may involve considerable overhead, bypassing these services when possible provides considerable overall performance.

As discussed in the Background section, conventional file systems and volume managers can provide various services through their I/O interfaces, such as encryption, compression, asynchrony, aggregation, queuing, and resource scheduling. For example, ZFS file systems provide these services through a ZIO interface, and the ZFS Intent Log (ZIL) module provides the functionality to commit intent log transactions to stable storage.

The present disclosure describes an improved system that avoids the high overhead services for simple requests such as a small write or file rename to a simple fast log device by adaptively bypassing a ZIO layer in the ZFS file system and issuing such low level requests to directly write the intent log blocks or flush the intent log devices write caches. This has been seen to lead to improve system performance by 10× on a micro scale or by 30% when measured at the system call API. As performance of synchronous requests is critical to operations of various types of applications being executed on a computing system, avoiding overhead services associated with simple write requests is highly desirable.

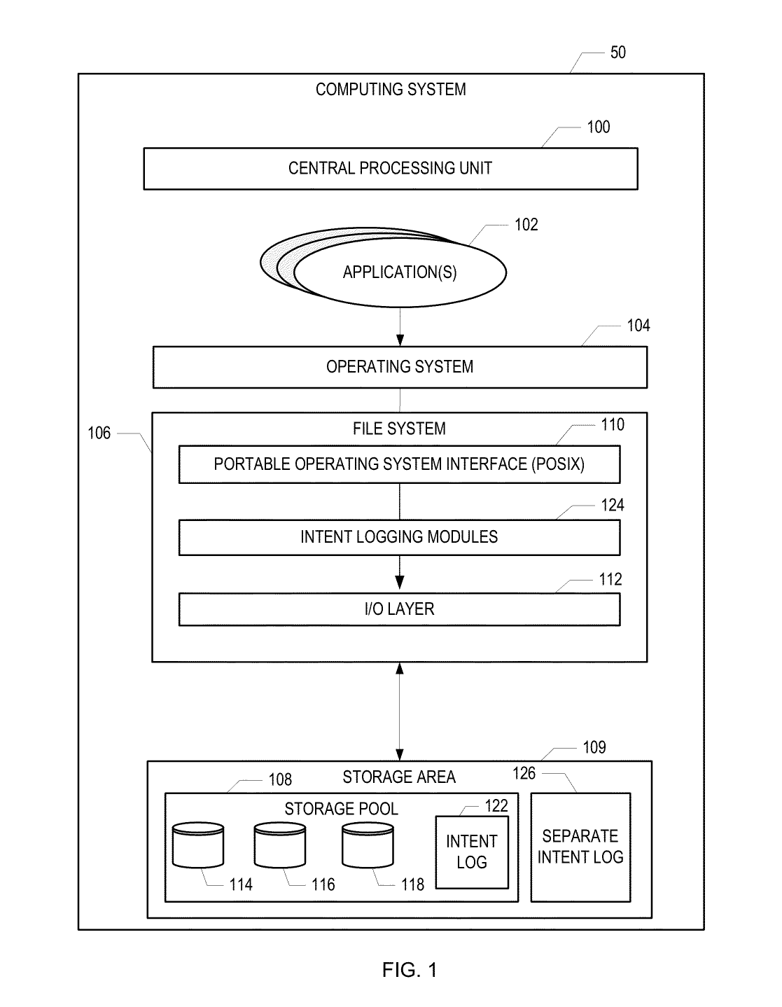

FIG. 1 depicts a computer architecture of a computing system 50 in accordance with an embodiment of the disclosure. The computing system 50 includes a central processing unit (CPU) 100 that may involve different processing arrangements involving one or more processors, one or more cores, and other computing devices. The CPU 100 is configured to execute one or more applications 102, an operating system 104, and/or a file system 106. The one or more applications 102 may be software applications that perform any number of tasks including database management, word processing, enterprise solutions, human resource management, etc. Each of one or more applications 102 works in conjunction with the operating system 104.

The operating system 104 provides an interface between the one or more applications 102 and computer hardware, so that each application can interact with the hardware according to rules and procedures provided by the operating system 104. The operating system 104 also includes functionality to interact with the file system 106, which in turn interfaces with a storage pool 108, whereby users may interact with stored data through read, write, open, close and other commands.

The operating system 104 typically interfaces with the file system 106 via a system call interface, such as a portable operating system interface (POSIX) 110. The POSIX interface 110 is the primary interface for interacting with the file system 106 and represents a standard that defines services that the file system 106 provides. Specifically, the POSIX interface 110 presents a file system abstraction of files and directories. The POSIX interface 110 takes instructions from the OS-kernel level (not shown) on input/output (I/O) requests.

According to one aspect, the file system 106 is an object-based file system (i.e., both file data and metadata are stored as objects). More specifically, the file system 106 includes functionality to store file data and corresponding file detail data in the storage pool 108. Thus, the aforementioned operations provided by the operating system 104 correspond to operations on objects.

A request to perform a particular operation is forwarded from the operating system 104, via the POSIX interface 110, to the file system 106. The file system 106 translates the request to perform an operation on an object directly to a request to perform a read or write operation (i.e., an I/O request) at a physical location within the storage pool 108. Further, the file system 106 includes functionality to read the data from the storage pool 108 or write the data into the storage pool 108.

For example, the file system 106 further includes an I/O layer 112 that facilitates the physical interaction between the file system 106 and the storage pool 108. The I/O layer 112 typically holds the I/O requests for a particular physical disk within the storage pool 108. For example, after a file update operation (or write operation) is initiated by a particular application 102, the application 102 issues a write I/O request (“write request”). The file system 106 can be configured to pass one or more data blocks representing the file update to the I/O layer 112 for routing to one of the physical storage devices and/or resources 114, 116, and 118 in the storage pool 108 located in a storage area 109.

According to another aspect, the file system 106 is a logical volume manager, such as provided by the ZFS file system. Unlike traditional file systems, which may reside on single devices and, thus, require a volume manager to use more than one device, ZFS file systems include virtual storage pools referred to as zpools. A zpool is constructed of virtual devices (vdevs), which are themselves constructed of block devices: files, hard drive partitions or entire drives, with the last being the recommended usage. Block devices within a vdev may be configured in different ways, depending on needs and space available: non-redundantly (similar to RAID 0), as a mirror (RAID 1) of two or more devices, as a RAID-Z (similar to RAID-5) group of three or more devices, or as a RAID-Z2 (similar to RAID-6) group of four or more devices.

A common operation initiated by an application 102 is a synchronous write request. When the application 102 issues a synchronous write request to write data, the application 102 must wait for a response from the file system that indicates the data has been written to stable storage, such as a hard disk in the storage pool 108 before continuing processing. Another common operation initiated by the application 102 is an asynchronous write request. When the application 102 issues an asynchronous write request to write data, the application continues without waiting even though the data may be buffered in a file system cache, but not yet written to disk. As a result, asynchronous writes are generally faster and, thus, less likely to affect the processing performance of the application as experienced by a user.

Often there is more to a write request than merely writing the data to disk. Namely, the I/O layer may provide a variety of different services for the request, which alone and collectively consume overhead (i.e. take additional processing time above that required to write the data to disc). Such services may include compression, encryption, aggregation, queuing, resource scheduling, and checksum validation. Because the application 102 must wait for data to be completely written to stable storage when issuing synchronous write request, the performance (e.g., processing time) of the application can be adversely affected as the number of synchronous write requests received by the file system 106 increase and those write requests also require additional services.

After the application 102 issues a synchronous write request, the file system 106 caches the data, such as in a level 1 cache including DRAM, but the application 102 also needs to ensure that the data is written to stable storage before continuing processing. A write operation, however, also involves storing the data in a non-volatile storage, such as spinning disks, as the data in the cache will eventually be evicted. Because writing data to the regular on-disk data structures requires additional processing time, the file system 106 is configured to temporarily store the data in an intent log 122, as well as the cache. Stated differently, before performing an operation corresponding to a synchronous write request, a record of the data associated with the intent to perform that particular operation is written in the intent log 122, which is typically stored in a non-volatile or other relatively permanent medium such as a hard disk. One purpose of the intent log 122 is to improve the resiliency of certain computer operations associated with issued write requests in the event of failures, such as power failures and/or hardware failures. For example, after the data has been written to the intent log 122, the write request complete status is returned back to the application 102 and the application 102 can continue providing a particular service and/or completing a particular task. Thus, the file system processes synchronous writes faster to commit them to stable storage in the intent log 122 and then write them to a storage pool, such as storage pool 108.

While the data is stored in the intent log 122, the various services required to complete or commit the write request may proceed without holding up the application. The file system 106 writes all the data accumulated in the intent log 122 to one or more of the storage devices 114, 116, and 118 in an orderly and efficient fashion. The intent log is also then updated and the intent log information for specific data that has been written to stable storage, which is marked as “completed.” This may occur at a specified interval (e.g., every 5 seconds). Should a failure occur, the file system 106 retrieves the required data from the intent log 122 after a reboot and replays the transaction record to complete the transaction.

Although the intent log 122 is primarily described herein in connection with logging data blocks for synchronous transactions, it is contemplated that data blocks associated with asynchronous transactions can also be maintained by the intent log 122. Asynchronous transactions are written to the intent log 122 when they are required by a synchronous transaction. For instance, a synchronous write to a file would force an asynchronous create transaction of that same file to be committed to the intent log if such a create transaction were present in the intent log.

Data can be written to the intent log 122 faster than it can be written to the regular storage pool 108 because the intent log 122 does not require the overhead of updating file system metadata and other housekeeping tasks. However, when the intent log 122 is located on the same disk or shares storage resources with the storage pool 108, there will be competition between the intent log 122 and the regular pool structures over processing resources. This competition can result in poor processing performance when there are a significant number of synchronous writes being issued by the one or more applications, for example. This can have the effect of the one or more application appearing slow to users.

According to aspects of the disclosure, the file system 106 includes one or more intent logging modules 124 to selectively write or record data included in a write request directly to a discrete or separate intent log (i.e., SLOG) 126 in the storage area 109. For example, the file system 106 may be configured to write data associated with a simple synchronous request to the SLOG 126. Simple synchronous requests, such as small write requests, do not require the high overhead services required by more complex write requests.

The intent logging modules 124 determine whether to write data to the SLOG 126 based on detail data (e.g., metadata) and/or other parameters associated with a received write request. The SLOG 126 is used to minimize processing delays when an application 102 issues multiple simple synchronous requests, such as a series of small write requests. According to one aspect, the SLOG 126 is, for example, provided by a flash or solid state drive (SSD). As a result, the competition between the intent log 122 and storage pool 108 for processing resources is reduced and, thus application response time is improved.

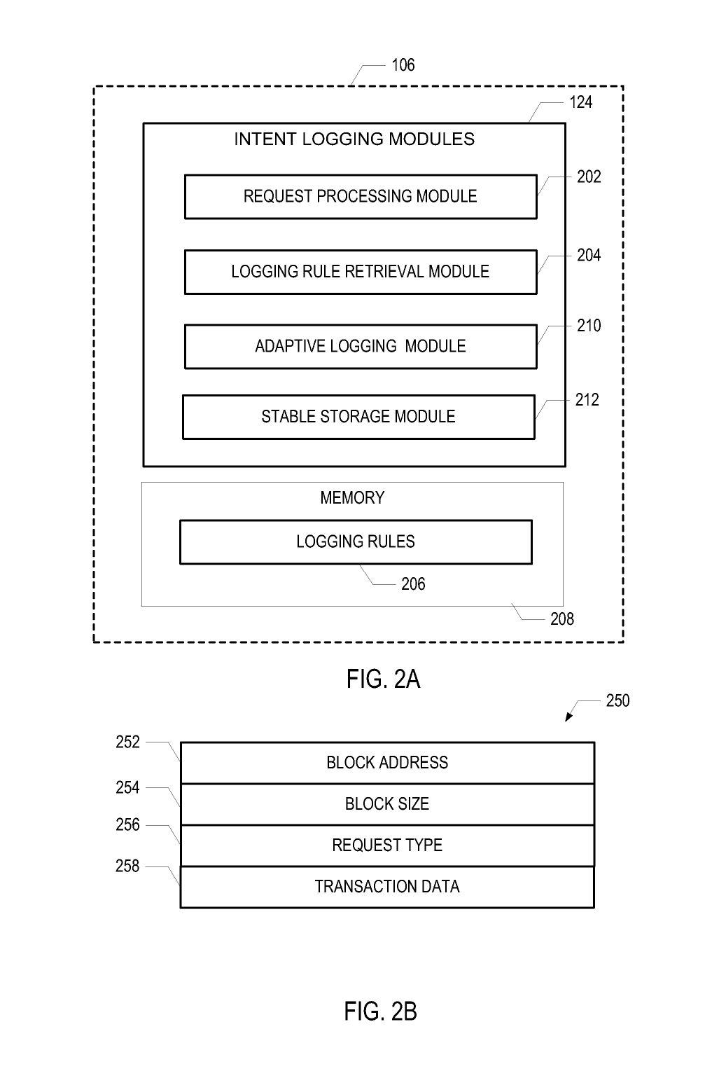

FIG. 2A is a block diagram depicting intent logging modules 124 of the file system 106 that are executable and/or executed by the CPU 100 to determine if data associated with a received write request should be written to the SLOG 126. As described above, the file system 106 receives write request from one or more applications 102 via the operating system 104. A request processing module 202 receives the write request, which includes block data such as a metadata or other detail data that describe the write request.

For example, referring to FIG. 2B, a write request 250 in accordance with an illustrative embodiment of the disclosure is depicted. In this example, the write request 250 includes detail data, such as a data block address 252, a data block length 254, a request type 256, and write transaction data 258. A block address 252 is an address that maps or points to a physical address for data that is stored to a media in a logical progression. The block length is the length, usually in bytes, of the associated data block. The request type 256 indicates, for example, whether write request is synchronous request or asynchronous request. It is contemplated that the write request may include additional information and data. Write transaction data 258 is, for example, data received from an application that is being written to the storage area 108.

Referring back to FIG. 2A, the request processing module 202 identifies the detail data included in the received write request. For example, the request processing module 202 processes the write request to identify a request type and/or a data block length or size.

A logging rule retrieval module 204 retrieves one or more logging rules 206 from a memory 208 associated with the file system 106 in response to the received write request. The logging rules 206 may define, for example, one or more constraints or parameters that can be used to determine if detail data associated with the write request should written directly to the SLOG 126 and, thus, bypass storage devices in the storage pool 108 that require more processing time. In one example, the logging rules 206 specify whether a particular request should be written to the SLOG 126 based on an identified request type. As described above, there are two primary types of requests: synchronous requests and asynchronous requests. According to one aspect, the logging rules 206 specify that detail data associated with synchronous type write requests are to be written directly to the SLOG 126.

As another example, the logging rules 206 may specify whether data associated with a particular write request should be written to the SLOG 126 based on a threshold amount of data (e.g., data block length or size) associated with that particular write request. According to one aspect, the logging rules 206 specify that write requests associated with data blocks that are equal to or less than 32 kilobytes are to be written directly to the SLOG 126.

It is further contemplated that the threshold amount or threshold size of data is user configurable. Stated differently, the threshold amount or size that controls whether detail data associated with a particular request is written directly to the SLOG 126 can be defined by an administrative user of the computing device.

As yet another example, the logging rules 206 specify whether a particular request should or can be written to the SLOG 126 based on the configuration of the storage pool. For example, a file system 106 that uses a certain level of RAID (Redundant Arrays of Independent Disks) with a certain amount of storage may not be capable of restoration on a different configuration. As described above, a zpool is constructed of virtual devices (vdevs), which are themselves constructed of block devices: files, hard drive partitions or entire drives, with the last being the recommended usage. Block devices within a vdev may be configured in different ways, depending on need and space available: non-redundantly (similar to RAID 0), as a mirror (RAID 1) of two or more devices, as a RAID-Z (similar to RAID 5 with regard to parity) group of three or more devices. According to one aspect, the logging rules 206 specify that complex write requests that involve large writes to a main pool device coupled with a log block write on RAID-Z or a RAID 5 are not to be written to the SLOG 126.

An adaptive logging module 210 processes the request detail data according to the logging rules 206 to determine if the data should be written to the SLOG 126 instead of the intent log 122. For example, if the write request is identified to be a synchronous type write request, the logging module 210 writes a record of the data associated with the synchronous type write request directly to the SLOG 126 in accordance with the retrieved logging rules 206.

According to another aspect, the adaptive logging module 210 processes the request detail data without logging rules 206 to determine if the data should be written to the storage pool 108 instead of the SLOG 126. For example, the adaptive logging module 210 includes software code or instructions, such as one or more “If-Then” statements, that determine whether to write a record of the data associated with the write request directly to the SLOG 126 if the write request is identified to be a synchronous type write request, is less than a predefined threshold amount, and/or a specific type of synchronous request.

A stable storage module 212 subsequently writes the data stored in the adaptive intent log to an appropriate storage resource (e.g., storage devices 114, 116, 118) in the storage pool 108. The file system 106 will then flush the contents of the intent log 122 at a specified interval (e.g., every 5 seconds).

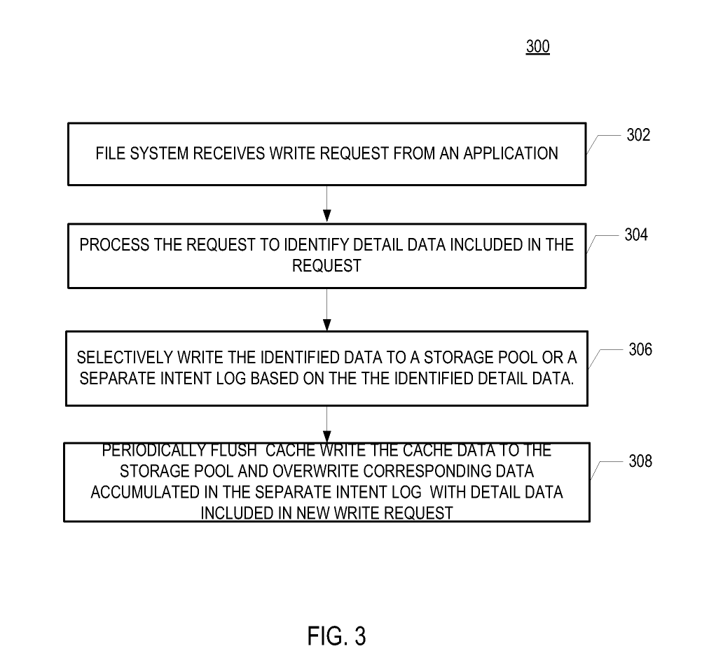

FIG. 3 depicts an exemplary process 300 performed by a file system 106 according to aspects the adaptive intent logging system. At 302, the file system 106 receives a write request from an application executing on the computing device. The file system process processes the write request to identify detail data included in the received write request at 304.

The file system 106 then selectively writes data included in the write request to a storage pool device in the storage pool 108 or a separate intent log (e.g., SLOG 126) based on the identified detail data at 306. As described above, the file system 106 may use logging rules that involve, for example, comparing detail data to an identified write request type and/or an identified a threshold amount of data associated with the request to determine whether to write the data to a storage pool device or the SLOG 126. Other examples of request logging rules exist. Alternatively, as described above, the file system 106 may process the request detail data without logging rules by using software code or instructions.

At 308, the file system 106 periodically flushes its caches and writes the cached data to the storage pool area and overwrites corresponding data accumulated in the SLOG 126 with detail data associated with new write request received at the file system 106 that are eligible for adaptive intent logging.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for adaptive intent logging in a file system comprising:
at least one processor;
a file system executing on the at least one processor to receive a write request from at least one application being executed by the at least one processor, the write request comprising detail data;
at least one intent logging module executed by the file system in response to the write request to:
process the detail data to determine if the write request is a first request type or a second request type;
write a record comprising at least a portion of the detail data to at least one storage pool device when the write request is the first request type; and
write the record comprising the at least the portion of the detail data to an intent log when the write request is the second request type.

2. The system of claim 1 wherein the at least one storage pool device is located within a storage pool and the intent log is separate from the storage pool.

3. The system of claim 1 wherein the file system is further configured to write another record to the at least one storage pool device after a predetermined amount of time when the write request is the second request type, the other record comprising the at least a portion of the detail data written to the intent log.

4. The system of claim 1 wherein the file system comprises an I/O layer, and wherein the at least the portion of the detail data being written to the at least one storage pool device requires at least one high overhead process operation at the I/O layer, and wherein the at least one high overhead process operation includes one or more of a compression operation, an encryption operation, an aggregation operation, a queuing operation a resource scheduling operation, and a checksum verification operation.

5. The system of claim 1 wherein the at least one intent logging module executed by the file system is further configured to:
retrieve a threshold block size value from a memory associated with the file system;
process detail data included in the I/O request to identify a size of a block of data associated with the I/O request; and
write the record to the at least one storage pool device when the size of the block of data is greater than the threshold block size value; or write the record to the intent log when the size of the block of data is less than or equal to the threshold block size value, wherein the threshold block size value equals 32 kilobytes.

6. The system of claim 1 wherein:
the first request type comprises a complex write request; and
the at least one intent logging module maps the complex write request to the at least one storage pool device.

7. The system of claim 1 wherein:
the second request type comprises a simple write request; and
the at least one intent logging module maps the simple write request to the intent log.

8. A system for adaptive intent logging by a file system operating on a computing device, the system comprising:
at least one processor;
a file system executing on the at least one processor to receive a write request from at least one application being executed by the at least one processor, the write request comprising detail data; and
at least one intent logging module executed by the file system in response to the I/O request to:
process the write request to identify one or more types of the detail data; and
selectively write a record comprising at least a portion of the detail data to one of a storage pool device and an intent log based on a comparison of the one or more types of detail data identified and one or more intent logging rules.

9. The system of claim 8 further comprising a memory comprising the one or more logging rules, wherein:
the one or more logging rules specify that the at least a portion of the detail data of a first synchronous write request type is to be recorded in the storage pool device and that the at least a portion of the detail data of a second synchronous write request type is to be recorded in the intent log; and
the at least one intent logging module executed by the file system is further configured to:
write the record to the storage pool device when the write request is identified as the first synchronous write request type; and
write the record to the intent log when the write request is identified as the second synchronous write request type.

10. The system of claim 9 wherein:
the storage pool device is located within a storage pool for the file system and the intent log is separate from the storage pool;
the first synchronous write request type comprises a complex write request;
the second synchronous write request type comprises a simple write request, and
wherein the at least one intent logging module:
maps the simple write request to the intent log; and
maps the complex write request to the storage pool device.

11. The system of the claim 8 wherein:
the one or more types of detail data comprises a block size;
the one or more intent logging rules specify recording the at least a portion of the detail data of the write request in the storage pool device when the block size exceeds a threshold block size value and specify recording the at least the portion of the detail data of the write request in the separate intent log when the block size is less than or equal to the threshold block size value; and
the at least one intent logging module executed by the file system is further configured to:
write a record to the storage pool device when the block size exceeds the threshold block size value; and
write the record to the intent log when the block size is less than or equal to the threshold block size value.

12. The system of claim 11 wherein the threshold block size value equals 32 kilobytes.

13. The system of claim 8 wherein write request is selected from a group consisting of compression request, an encryption request, an aggregation request, a queuing request, a resource scheduling request, and a checksum verification request.

14. The system of the claim 8 wherein:
the one or more intent logging rules specify recording the at least the portion of the detail data of the write request in the storage pool device when the storage pool device belongs to a storage pool configuration that corresponds to a RAID Z configuration; and
the at least one intent logging module executed by the file system is further configured to write the record to the storage pool device when the storage pool configuration corresponds to a RAID Z configuration.

15. The system of claim 9 wherein the intent log comprises one or more of a flash and a solid state drive (SSD).

16. A method for adaptive intent logging in a file system, the method comprising:
receiving a write request at a file system executing on at least one processor from at least one application being executed by the at least one processor, the write request comprising detail data;
processing the detail data to determine if the write request is a first request type or a second request type;
writing a record comprising at least a portion of the detail data to at least one storage pool device when the write request is the first request type; and
writing the record comprising the at least the portion of the detail data to an intent log when the write request is the second request type.

17. The method of claim 16 wherein the at least one storage pool device is located within a storage pool and the intent log is separate from the storage pool.

18. The method of claim 16 further comprising writing another record to the at least one storage pool device after a predetermined amount of time when the write request is the second request type, the other record comprising the at least a portion of the detail data written to the intent log.

19. The method of claim 16 wherein the at least a portion of the detail data being written to the at least one storage pool device requires at least one high overhead process operation at an I/O layer in the file system, and wherein the at lest one high overhead process operation includes one or more of a compression operation, an encryption operation, an aggregation operation, a queuing operation a resource scheduling operation, and a checksum verification operation.

20. The method of claim 19 further comprising:
retrieving a threshold block size value from a memory associated with the file system;
processing detail data included in the write request to identify a size of a block of data associated with the write request;
writing the record to the at least one storage pool device when the size of the block of data is greater than the threshold block size value; and
writing the record to the intent log when the size of the block of data is less than or equal to the threshold block size value.

21. The method of claim 16 wherein the first request type comprises a simple write request and the second request type comprises with a complex write request, and the method further comprising:
mapping the complex write request to the at least one storage pool device; and
mapping the simple write request to the intent log.
